(19) United States
(12) Patent Application Publication
(10) Pub. No.: US 2020/0361375 A1
(43) Pub. Date: Nov. 19, 2020

(54) IMAGE PROCESSING DEVICE AND VEHICLE LAMP

(71) Applicant: KOITO MANUFACTURING CO., LTD., Tokyo (JP)

(72) Inventor: Mitsuharu MANO, Shizuoka-shi (JP)

(73) Assignee: KOITO MANUFACTURING CO., LTD., Tokyo (JP)

(21) Appl. No.: 16/985,344

(22) Filed: Aug. 5, 2020

Related U.S. Application Data
(63) Continuation of application No. PCT/JP2019/004101, filed on Feb. 5, 2019.

(30) Foreign Application Priority Data
Feb. 7, 2018 (JP) 2018-020397

(51) Int. Cl. B60Q 11/00; B60Q 1/08; G06T 7/90; H04N 5/232; B60K 35/00

(52) U.S. Cl. CPC B60Q 11/005; B60Q 1/085; G06T 7/90; H04N 5/23229; G06T 2207/30252; B60Q 2300/314; B60Q 2300/41; B60Q 2300/42; B60K 2370/176; B60K 35/00

(57) ABSTRACT

An image processing device includes: an identification unit that identifies whether an attribute of a first light spot included in image information capturing a scenery in front of a vehicle is a facility related to a road, by referring to first feature information on the first light spot calculated by referring to the image information; and a storage unit that stores the first feature information when the attribute of the first light spot is identified as a facility related to the road. The identification unit identifies whether an attribute of a second light spot included in the image information is a facility related to the road, by using the first feature information stored.

### CROSS-REFERENCE TO RELATED APPLICATIONS

This application is based upon and claims the benefit of priority from the prior Japanese Patent Application No. 2018-020397, filed on Feb. 7, 2018 and International Patent Application No. PCT/JP2019/004101, filed on Feb. 5, 2019, the entire content of each of which is incorporated herein by reference.

### BACKGROUND OF THE INVENTION

### 1. Field of the Invention

The present invention relates to an image processing device used in vehicles, etc.

### 2. Description of the Related Art

In recent years, various attempts have been made to identify an environment or an object around, based on information on the surrounding acquired by a camera or a sensor mounted to a vehicle and to perform vehicle control adapted to the environment or the object. Vehicle control is exemplified by braking control, drive control, user operation control, light distribution control, etc.

For example, a vehicle headlamp device provided with an image processing means for calculating an optical flow of an object located in front of the vehicle as a light emitting object or a light reflector, based on brightness information of an image obtained and capturing a scene in front of the vehicle and for identifying the attribute of the object based on the optical flow (patent literature 1). The vehicle headlamp device realizes light distribution control that prevents glare from being experienced in a leading vehicle or an oncoming vehicle, in accordance with the attribute of the object thus identified.

[Patent literature 1] JP2013-163518

However, it is not easy to discriminate, in an image captured at night, a light spot representing a vehicle (the tail lamp of a leading vehicle or the headlamp of an oncoming vehicle) from the other light spots (street lamps, reflectors, etc.). In particular, a distant light spot is small and dark so that accurate discrimination is not easy.

### SUMMARY OF THE INVENTION

The present invention addresses the above-described issue, and an illustrative purpose thereof is to provide a novel technology for identifying the attribute of a light spot located in front of the vehicle precisely.

An image processing device according to an embodiment of the present invention includes: an identification unit that identifies whether an attribute of a first light spot included in image information capturing a scenery in front of a vehicle is a facility related to a road, by referring to first feature information on the first light spot calculated by referring to the image information; and a storage unit that stores the first feature information when the attribute of the first light spot is identified as a facility related to the road. The identification unit identifies whether an attribute of a second light spot included in the image information is a facility related to the road, by using the first feature information stored.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a schematic diagram showing an appearance of a vehicle to which a vehicle lamp according to the embodiment is applied;

FIG. 2 is a block diagram showing a schematic configuration of the vehicle lamp according to the embodiment;

FIG. 3 is a flowchart showing a light distribution control method according to the embodiment including a process of identifying the attribute of a light spot;

FIG. 4A is a schematic diagram showing a situation where only road lights are located as light emitting objects on a straight road at night as seen from the forward monitoring camera, and FIG. 4B is a schematic diagram showing a situation where road lights and vehicles in front are located as light emitting objects on a straight road at night as seen from the forward monitoring camera;

FIG. 5A is a schematic diagram showing a situation where only delineators are located as reflectors on a straight road at night as seen from the forward monitoring camera, and FIG. 5B is a schematic diagram showing a situation where delineators and vehicles in front are located on a straight road at night as seen from the forward monitoring camera;

FIG. 6A shows a track of light spots that result when the behavior of the vehicle is stable, and FIG. 6B shows the movement of light spots that result when the vehicle pitches;

FIG. 7 is a flowchart showing a process for identifying the movement of the driver's vehicle by using a distant light spot;

FIG. 8A schematically shows an imaging range of the forward monitoring camera in a state in which the vehicle does not pitch, FIG. 8B shows lanes (white lines) in the imaging range shown in FIG. 8A, FIG. 8C schematically shows an imaging range of the forward monitoring camera in a state in which the vehicle pitches, and FIG. 8D shows lanes (white lines) in the imaging range shown in FIG. 8C; and

FIG. 9 is a flowchart showing a process of determining the movement of the driver's vehicle by using a nearby white line.

### DETAILED DESCRIPTION OF THE INVENTION

Hereinafter, the invention will be described based on preferred embodiments with reference to the accompanying drawings. Identical or like constituting elements, members, processes shown in the drawings are represented by identical symbols and a duplicate description will be omitted. The embodiments do not intend to limit the scope of the invention but exemplify the invention. Not all of the features and the combinations thereof described in the embodiments are necessarily essential to the invention.

An image processing device according to an embodiment of the present invention includes: an identification unit that identifies whether an attribute of a first light spot included in image information capturing a scenery in front of a vehicle is a facility related to a road, by referring to first feature information on the first light spot calculated by referring to the image information; and a storage unit that stores the first feature information when the attribute of the first light spot is identified as a facility related to the road. The identification unit identifies whether an attribute of a second light spot included in the image information is a facility related to the road, by using the first feature information stored.

According to this embodiment, whether the attribute of the second light spot is a facility related to the road is identified based on the first feature information stored. Accordingly, the attribute of the second light spot can be identified more precisely as compared with the case of identifying whether the attribute is a facility related to the road based only on the second light spot calculated by referring to the image information.

The identification unit may identify the attribute of the second light spot by comparing second feature information on the second light spot calculated by referring to the image information with the first feature information stored. This improves the precision of identification of the attribute of the second light spot as compared with the case of identifying the attribute of the second light spot based only on the second feature information.

When the second feature information has information in common with the first feature information, the identification unit may identify that the attribute of the second light spot is a facility related to the road. This improves the precision with which the attribute of the second light spot is identified as a facility related to the road.

When the identification unit identifies that the attribute of the second light spot is not a facility related to the road, the identification unit may identify whether the attribute of the second light spot is a vehicle in front traveling in front of the vehicle, based on the second feature information. This makes it easy to identify whether the attribute of the second light spot is a vehicle in front or not since it has already been identified that the attribute of the second light spot is not a facility related to the road.

The identification unit may identify the attribute of the first light spot by using the first feature information calculated by referring to a nearby range in the image information that excludes a distant range including a vanishing point. It is difficult to identify a light spot of a reflector such as a delineator from a distance. For this reason, the precision of identification may be lowered if the feature information is calculated by including a distant range. This embodiment improves the precision of identification of the attribute of the first light spot by using the first feature information calculated by excluding the distant range.

Another embodiment of the present invention relates to a vehicle lamp. The vehicle lamp includes: the image processing device; a headlamp unit that irradiates a space in front of the vehicle; and a light distribution control unit that controls light distribution of the headlamp unit in accordance with the attribute of the light spot identified by the image processing device. Thus, it is possible to control light distribution to suit the attribute of the object in front of the vehicle without imposing a special burden for user operation on the driver.

The light distribution control unit excludes the light spot for which the attribute is not identified by the image processing device as a vehicle in front, which is traveling in front of the vehicle, from targets of light distribution control of the headlamp unit. The light spot for which the attribute is not identified as a vehicle in front is exemplified by a facility related to the road. It is therefore not necessary to allow for an impact of glare on those facilities. Accordingly, light control that improves the visibility in front of the vehicle is possible.

Optional combinations of the aforementioned constituting elements, and implementations of the invention in the form of methods, apparatuses, and systems may also be practiced as additional modes of the present invention.

### (Vehicle Lamp)

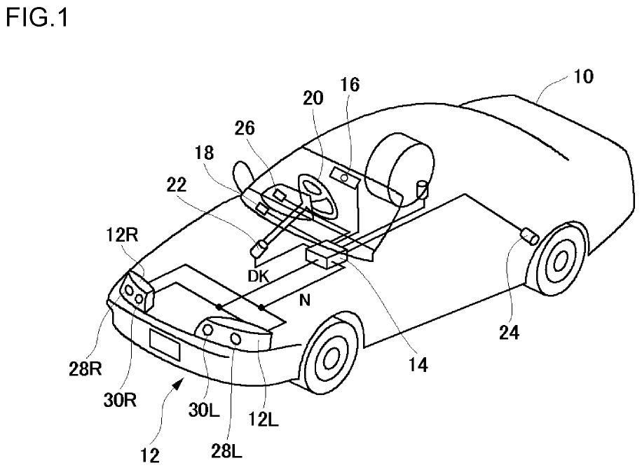

FIG. 1 is a schematic diagram showing an appearance of a vehicle to which a vehicle lamp according to the first embodiment is applied. As shown in FIG. 1, a vehicle 10 according to this embodiment includes a headlamp unit 12, a control system 14 for controlling light irradiation by the headlamp unit 12, various sensors for detecting information indicating a traveling condition of the vehicle 10 and outputting a detection signal to the control system 14, a forward monitoring camera 16 for monitoring a space in front of the vehicle, and an antenna 18 for receiving an orbital signal from a GPS satellite and outputting the signal to the control system 14.

Various sensors provided include a steering sensor 22 for detecting the steering angle of a steering wheel 20, a vehicle speed sensor 24 for detecting the vehicle speed of the vehicle 10, and an illuminance sensor 26 for detecting the illuminance around the driver's vehicle. These sensors 22, 24, and 26 are connected to the control system 14 mentioned above.

In order to use the forward monitoring camera 16 for light distribution control of the headlamp unit (headlight), the forward monitoring camera 16 is required to be capable of discriminating between objects in front of the vehicle at night. However, various objects could be located in front of the vehicle. For some objects such as an oncoming vehicle or a leading vehicle, light distribution control that allows for glare is necessary. For others such as road lights and delineators (visual guidance signs), light distribution control most suitable for the driver's vehicle may be performed without allowing for glare.

In order to realize such light distribution control of the headlamp unit, it is preferred to use a camera capable of sensing a light emitting object and a light reflector. The light emitting object is exemplified by as a vehicle in front (a leading vehicle or an oncoming vehicle) traveling in front the driver's vehicle or a road light. The light reflector is exemplified by a delineator. In addition, it is more preferred that a function be provided for identifying the attribute of the light emitting object or the light reflector sensed as an object. The attribute in this case identifies whether the light emitting object or the light reflector in front is a vehicle in front or a road related facility. To be more specific, the attribute identifies whether the light emitting object, etc. identified as a vehicle is a leading vehicle or an oncoming vehicle, or whether the light emitting object, etc. identified as a road related facility is a road light, a delineator, any of other facilities emitting light (e.g., shop illumination, advertisement, etc.), or a traffic signal.

The embodiment is non-limiting as to the headlamp unit that can be applied to the embodiment so long as light distribution of irradiating light can be changed depending on the attribute of the object located in front. For example, a headlamp in which a halogen lamp, a gas discharge headlamp, or a semiconductor light emitting element (LED, LD, EL) is used can be employed. In this embodiment, a headlamp unit configured not to radiate a partial region in the light distribution pattern to prevent glare from being experienced in vehicles in front is described by way of example. Configurations capable of not radiating a partial region in the light distribution pattern from include a configuration to drive a shade to shield a portion of the light from the light source and a configuration not to turn on some of a plurality of light emitting units.

The headlamp unit 12 includes a pair of right and left headlamp units 12R and 12L. The headlamp units 12R and 12L have the same configuration except that the internal structures are horizontally symmetrical. A low beam lamp unit 28R and a high beam lamp unit 30R are provided in the right side lamp housing, and a low beam lamp unit 28L and a high beam lamp unit 30L are provided in the left side lamp housing, respectively.

Based on outputs of the various sensors input to the control system 14, the control system 14 controls the headlamp units 12R and 12L provided at the right and left ends of the front of the vehicle, i.e., controls the headlamp unit 12 capable of changing its light distribution characteristic by not radiating a partial region in the light distribution pattern.

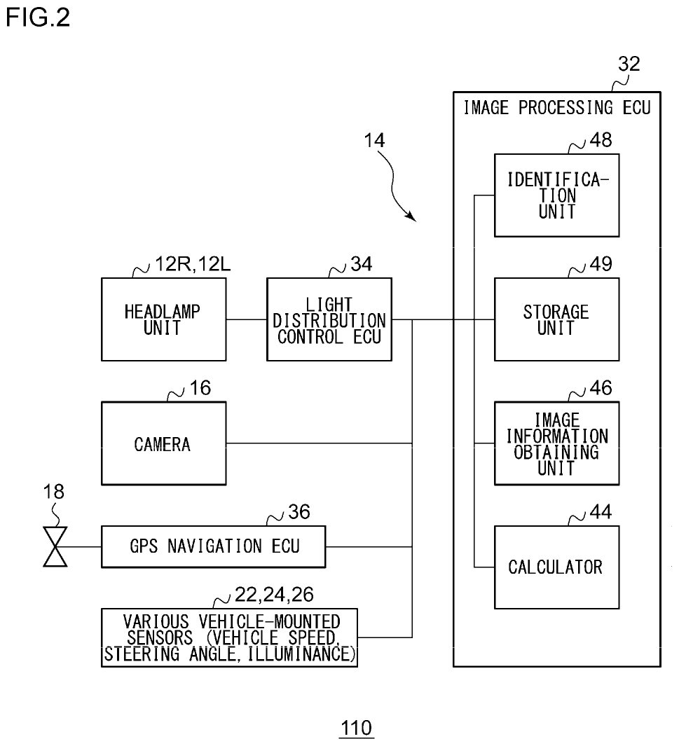

A description will now be given of the vehicle lamp according to this embodiment. FIG. 2 is a block diagram showing a schematic configuration of a vehicle lamp 110 according to the embodiment. The vehicle lamp 110 includes the headlamp units 12R and 12L and the control system 14 for controlling light irradiation by the headlamp units 12R and 12L. The control system 14 of the vehicle lamp 110 identifies the attribute of an object located in front of the vehicle, determines a light distribution control condition based on the attribute of the object, and controls light irradiation by the headlamp units 12R and 12L based on the light distribution control condition thus determined.

For this purpose, a forward monitoring camera 16 for obtaining an image that captures a scenery in front of the vehicle, including a target viewed by the driver, is connected to the control system 14 according to the embodiment. Further, the steering sensor 22 and the vehicle speed sensor 24 for respectively detecting steering information and vehicle speed, which are referred to when determining the traveling condition of the vehicle, and the illuminance sensor 26 are also connected.

### (Control System)

The control system 14 is provided with an image processing ECU 32, a light distribution control ECU 34, and a GPS navigation ECU 36. The ECUs and the vehicle-mounted sensors are connected via a vehicular LAN and are capable of transmitting and receiving data. The image processing ECU 32 identifies the attribute of an object located in front based on data for the captured image obtained by the forward monitoring camera 16 and on the vehicle-mounted sensors. The light distribution control ECU 34 determines a light distribution control condition suited to the traveling environment in which the vehicle is placed, based on information from the image processing ECU 32 and the vehicle-mounted sensors.

The light distribution of the headlamp units 12R and 12L is controlled when the control signal output from the light distribution control ECU 34 is input to the drive device for the optical components and to the lighting control circuit of the light source. The forward monitoring camera 16 is a single-eye zoom camera provided with an image sensor such as a CCD and a CMOS. The forward monitoring camera 16 refers to the image data obtain road alignment information and information on the presence or position of road related facilities, leading vehicles, and oncoming vehicles, etc.

### (Attribute Identification Process)

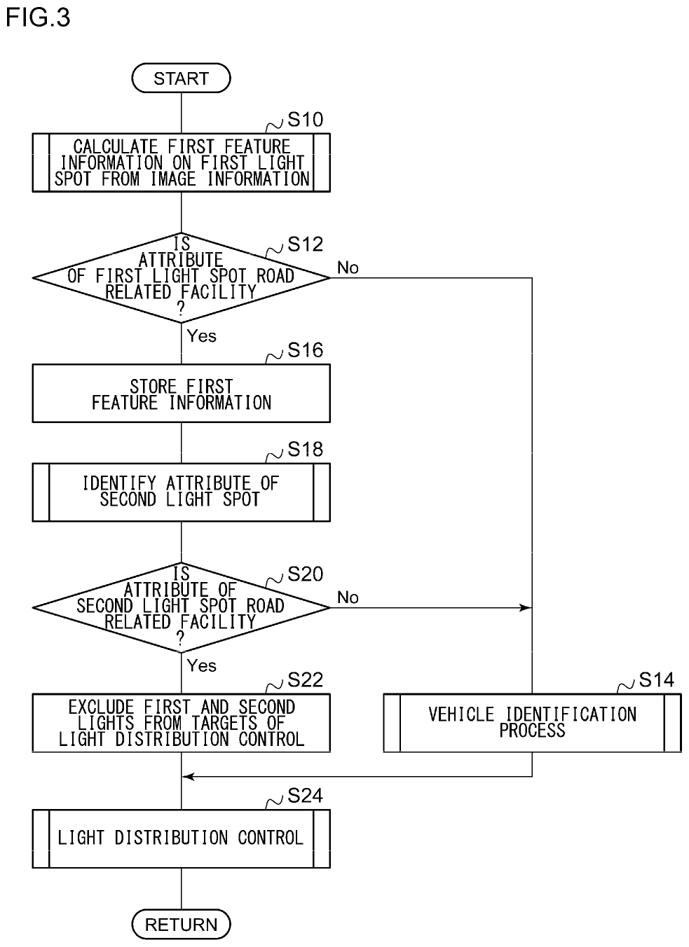

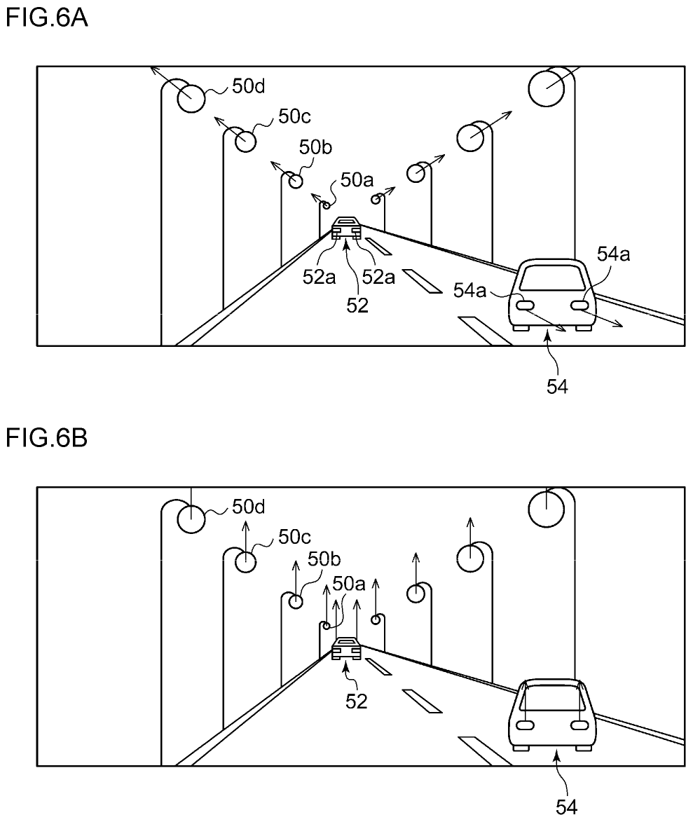

A description will now be given of a process of identifying the attribute of a light spot performed in the image processing ECU according to this embodiment. The attribute identification process according to this embodiment is identification of the object attribute of a light spot by using feature information used to identify the object attribute of another light spot. FIG. 3 is a flowchart showing a light distribution control method according to this embodiment including a process of identifying the attribute of a light spot. Identification of the object attribute is mainly performed in the image processing ECU 32 shown in FIG. 6, and light distribution control is mainly performed in the light distribution control ECU 34. The image processing ECU 32 according to this embodiment refers to feature information such as the movement, size, brightness, position, track, etc. of a light spot included in the captured image information to identify the attribute of an object corresponding to the light spot.

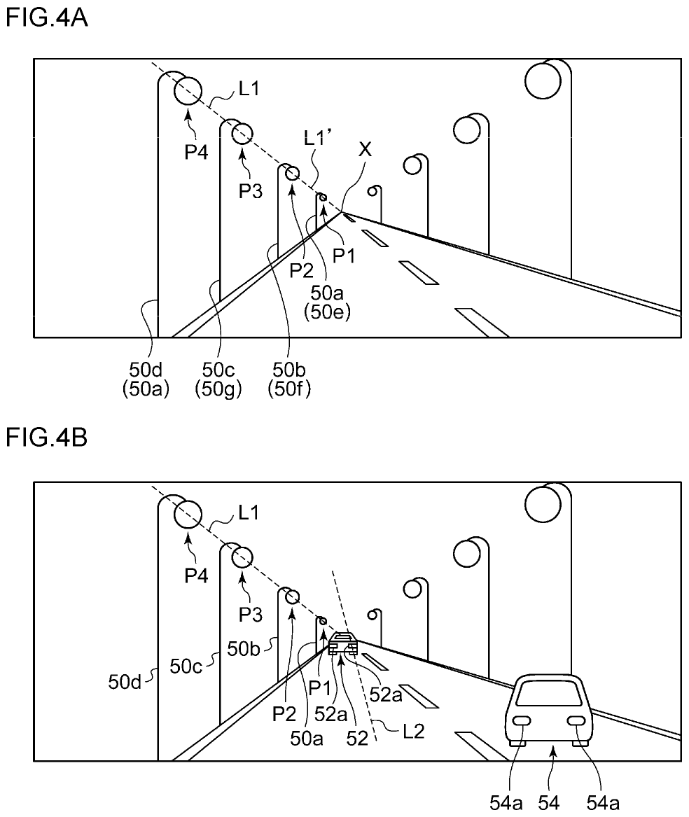

FIG. 4A is a schematic diagram showing a situation where only road lights are located as light emitting objects on a straight road at night as seen from the forward monitoring camera, and FIG. 4B is a schematic diagram showing a situation where road lights and vehicles in front are located as light emitting objects on a straight road at night as seen from the forward monitoring camera.

When the process is started according to a predetermined timing schedule, the image processing ECU 32 according to this embodiment performs the first feature information calculating step of calculating the first feature information on the first light point by referring to the image information (S10).

More specifically, image information capturing a scene in front of the vehicle by using the forward monitoring camera 16 is obtained by an image information obtaining unit 46 in the first feature information calculation step. A calculator 44 calculates the first feature information on the first light spot by referring to the image information obtained by the image information obtaining unit 46. The description here concerns a single light spot, but it is needless to say that a plurality of light spots may be processed in parallel or serially.

A publicly known technology may be applied to the method of calculating the first feature information. An exemplary method of identifying a distant object will be shown below. The position of a light emitting object on a straight road at night as seen from the image sensor provided in the forward monitoring camera 16 is located within a certain range relative to the vanishing point.

### (Vanishing Point)

A vanishing point is defined as a point of convergence in a perspective in a picture. A vanishing point is a point at infinity for a lane mark, side strip, center divider, road related facilities arranged at regular intervals (road lights, delineators), etc. In the case a point at infinity cannot be determined due to the road shape (e.g., a curve), the presence of a vehicle in front, etc., the arrangement of those objects in a near view may be extended to infinity to define a provisional vanishing point may by estimating the intersection on the screen.

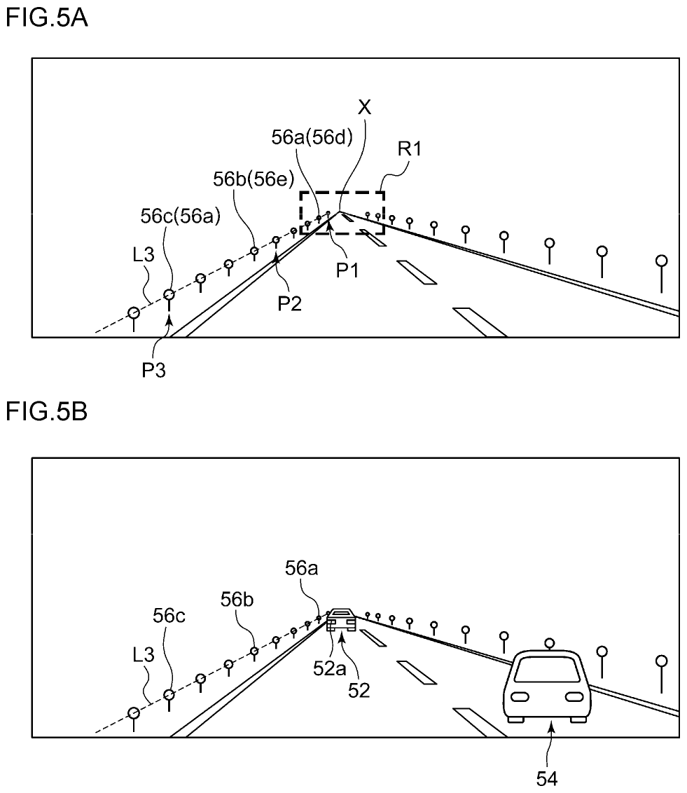

More specifically, the road light that is a road related facility is positioned, in the perspective view, above the H line (horizontal line) including the vanishing point (see FIG. 4A), and the delineator that is also a road related facility is positioned slightly below the H line (see FIG. 5A described later). While the vehicle is traveling, the road light moves within the screen along a track that extends diagonally upward from the vanishing point X in the figure. Further, the delineator moves within the screen while the vehicle is traveling along a track that extends diagonally downward from the vanishing point X in the figure. Comparing images obtained after an elapse of a predetermined period of time, an optical flow [OF (Optical Flow); a vector representation of the movement of the object in visual representation (normally temporally successive digital images)] is created along the line. The OF can be used as the track of the light spot.

Road lights 50a-50d shown in FIG. 4A represent street lights of the same height provided at equal distances. In the image obtained after an elapse of a predetermined period of time, therefore, the light spot of the road light 50a located at a position P1 previously has moved to a position P2 where the road light 50b had been. The light spot of the road light 50b located at the position P2 previously has moved to a position P3 where the road light 50c had been. The light spot of the road light 50c located at the position P3 previously has moved to a position P4 where the road light 50d had been.

In other words, the first light spot of the road light 50a located at the position P1 near the vanishing point X in the n-th frame image obtained by the image information obtaining unit 46 moves to the position P4 in the n+m frame image where the road light 50d had been in the n-th frame image. The calculator 44 calculates a track L1 as feature information by referring to history information on the first light spot in a plurality of images. Since the track L1 is a straight line that extends diagonally upward from the vanishing point X, an identification unit 48 identifies the attribute of the first light spot as a road light (road related facility) (Yes in S12). In that case, a storage unit 49 stores, as the history information, the track L1 that is the first feature information used to identify the attribute of the first light spot (S14).

The attribute of the second light spot is then identified (S18). As in the case of the first light spot, the second light spot is detected from the image information obtained by the image information obtaining unit 46. As described above, when the road light 50a detected as the first light spot has moved to the position P4, new road lights 50e-50g (see FIG. 4A) are seen approaching farther from the road light 50a. The new road lights 50e-50g may be individually processed as the first light spot to identify their attribute. In that case, however, the processing time and the volume of computation will be increased.

In this background, the calculator 44 calculates the individual positions P1-P3 of the light spots corresponding to the road lights 50e-50g as the second feature information on the second light spot. The identification unit 48 then compares the second feature information with the first feature information stored in the storage unit 49 and identifies the attribute of the second light spot as a road light because the second light spot is located within a range of the track L1 as the history information (Yes in S20). It is not necessarily the case that the same road related facilities are provided at equal distances, and a series of a plurality of light spots may not be completely aligned on a line so that the track may have a certain width.

Thus, the image processing ECU 32 according to this embodiment identifies whether the attribute of the second light spot is a road related facility based on the first feature information stored. Therefore, the image processing ECU 32 can identify the attribute of the second light spot more easily as compared with the case of identifying whether the light spot represents a facility related to the road based only on the second light spot calculated by referring to the image information. Further, the precision of identification of the attribute of the second light spot is improved as compared with the case of identifying the attribute of the second light spot based only on the second feature information. Further, the calculator 44 may calculate the track by using the subsequent history of the second light spot already identified to have the attribute of a road related facility and may use the track to identify the attribute of a light spot appearing in an image after the second light spot.

The light distribution control ECU 34 excludes the first light spot and the second light spot identified as road lights from the targets of light distribution control (S22). Light spots that are not identified as vehicles in front are, for example, facilities related to the road. It is therefore not necessary to allow for an impact of glare on those facilities. In other words, light distribution control that improves visibility in front of the vehicle is possible by controlling the headlamp unit 12 to irradiate a range including the first light spot and the second light spot identified as not being a vehicle for which an impact of glare need be allowed for.

Thus, the vehicle lamp 110 according to this embodiment is capable of performing light distribution control suited to the attribute of the object in front of the vehicle without imposing a special burden for user operation on the driver.

A description will now be given of the case where the first light spot or the second light spot is not a road related facility. As shown in FIG. 4B, there are cases where a leading vehicle 52 or an oncoming vehicle 54 is located in front of the vehicle other than the road lights 50a-50d. Therefore, when the identification unit 48 identifies that the attribute of the first light spot is not a road related facility by using a publicly known technology (No in S12), or when the identification unit 48 identifies that the attribute of the second light spot is not a road related facility (No in S20), a vehicle identification process (S14) is performed.

(Identification of the Attribute of the Object by using an Optical Flow)

Identification of the leading vehicle 52 or the oncoming vehicle 54 may be performed by using, for example, an optical flow. When the relative positions of the image sensor (camera) and the object on the road changes, the image of the object flows in images captured successively. The phenomenon is called an optical flow (hereinafter, referred to as “OF” as appropriate). The smaller the relative distance between the driver's vehicle and the object and the larger the relative speed difference, the larger the OF. In the case the driver's vehicle is at a stop, for example, an OF associated with a moving object is created. Further, in the case the driver's vehicle is traveling, an OF associated with a fixed object on the road such as a road light and a delineator is created, and an OF associated with a vehicle in front traveling at a speed different from that of the driver's vehicle is created. In this background, it is possible to identify whether the attribute of an object in front of the driver's vehicle is a moving object or a fixed object relative to the road, based on the magnitude of OF (optical flow quantity).

The optical flow quantity (vector quantity) is larger for objects near the image sensor other objects. Further, the larger the relative speed difference, the larger the optical flow quantity. In other words, the optical flow quantity relative to a traveling vehicle is defined such that the OF quantity of the oncoming vehicle 54>the OF quantity of the fixed object>the OF quantity of the leading vehicle 52. The attribute (leading vehicle, oncoming vehicle, road light, delineator, etc.) of the object can be identified by referring to the OF quantity and the position of the object on the road. Further, a tail lamp 52a or a headlamp 54a are configured as a pair of lamps, and the lamps in the pair have the same OF quantity. Therefore, the precision of identification of the attribute of the object can be further improved by also taking this fact into account. It is also possible to improve the precision of identification of the object by also taking into account the color of the tail lamp 52a or the headlamp 54a.

Thus, the identification unit 48 identifies a vehicle by taking into account the magnitude of OF quantity, color of the light spot, position of the light spot, movement of the light spot, etc. calculated by referring to the image information. The light distribution control ECU 34 performs light distribution control so as not to irradiate a space around the light spot determined as a vehicle (S24).

In the case the second light spot is positioned within a range of the track L1, which is the history information stored in the storage unit 49, the identification unit 48 identifies in step S18 that the attribute of the second light spot is a road light. In the case the tail lamp 52a of the leading vehicle 52 is positioned on an extension of the track L1 of the light spots of the road lights 50a-50d as shown in FIG. 4B, however, the attribute of the light spot corresponding to the tail lamp 52a may be falsely identified as a road related facility in S18.

This is addressed by identifying, in S18, whether the attribute of the second light spot is a road light by also allowing for whether the second light spot is red or not (whether the light spot of the leading vehicle is a tail lamp or not) or allowing for the brightness or size of the second light spot, etc. This reduces the likelihood of falsely identifying in S18 the attribute of the light spot corresponding to the vehicle in front as a road related facility.

Further, the identification unit 48 may identify that the attribute of the second light spot is a road related facility when the second feature information has information in common with the first feature information. In the case of the leading vehicle 52 mentioned above and shown in FIG. 4B, for example, the leading vehicle 52 may be located on an extension of the track L1 at a given point of time but may likely have moved to a position distanced from the extension of the track L1 at another point of time. Accordingly, the calculator 44 calculates a track L2 as the second feature information by referring to the history information on the second light spot in a plurality of images. The identification unit 48 compares the track L1 that is the first feature information with the track L2 that is the second feature information and identifies the attribute of the second light spot.

In the case of the road light 50e mentioned above and shown in FIG. 4A, on the other hand, the light spot is located on the track L1 at any of the points of time associated with the position P1 near the vanishing point through the position P4 going out of the frame. Therefore, the calculator 44 calculates a track L1′ as the second feature information by referring to the history information showing the light spot of the road light 50e moving from the position P1 to the position P2. The identification unit 48 compares the track L1 that is the first feature information with the track L1′ that is the second feature information and identifies the attribute of the second light spot, which shares the overlapping first light spot the track L1′ as common information, as a road related facility. This makes it possible to identify that the attribute of the second light spot is a road related facility before the second light spot moves to the position P4.

Further, when the identification unit 48 identifies that the attribute of the second light spot is not a road related facility (No in S20), the identification unit 48 identifies whether the attribute of the second light spot is a vehicle in front traveling in front of the vehicle, based on the second feature information. Since it is already identified that the attribute of the second light spot is not a facility related to the road in step S20, this makes it relatively easy to identify whether the attribute of the second light spot is a vehicle in front or not in step S14.

### (Delineator)

A description will now be given of a process of identifying the attribute of a light spot in the case the road related facility is a delineator. FIG. 5A is a schematic diagram showing a situation where only delineators are located as reflectors on a straight road at night as seen from the forward monitoring camera, and FIG. 5B is a schematic diagram showing a situation where delineators and vehicles in front are located on a straight road at night as seen from the forward monitoring camera. In the description of a process of identifying the attribute of a delineator, the same description as given above for road lights is omitted as appropriate.

Delineators 56a-56c shown in FIG. 5A move within the screen while the vehicle is traveling along a track that extends diagonally downward from the vanishing point X in the figure, as described above. The delineators 56a-56c shown in FIG. 5A are reflectors of the same height provided at equal distances. In the image obtained after an elapse of a predetermined period of time, therefore, the light spot of the delineator 56a located at a position P1 previously has moved to a position P2 where the delineator 56b had been. The light spot of the delineator 56b located at the position P2 previously has moved to a position P3 where the delineator 56c had been.

In other words, the first light spot of the delineator 56a located at the position P1 near the vanishing point X in the n-th frame image obtained by the image information obtaining unit 46 moves to the position P3 in the n+m frame image where the delineator 56c had been in the n-th frame image. The calculator 44 calculates a track L3 as feature information by referring to the history information on the first light spot in a plurality of images. Since the track L3 is a straight line that extends diagonally downward from the vanishing point X, the identification unit 48 identifies the attribute of the first light spot as a delineator (road related facility) (Yes in S12). In that case, the storage unit 49 stores, as history information, the track L3 that is the first feature information used to identify the attribute of the first light spot (S14).

The attribute of the second light spot is then identified (S18). As in the case of the first light spot, the second light spot is detected by referring to the image information obtained by the image information obtaining unit 46. As described above, when the delineator 56a detected as the first light spot has moved to the position P3, new delineators 56d and 56e (see FIG. 5A) are seen approaching farther from the delineator 56a. The new delineators 56d and 56e may be individually processed as the first light spot to identify their attribute. In that case, however, the processing time and the volume of computation will be increased.

In this background, the calculator 44 calculates the individual positions P1 and P2 of the light spots corresponding to the delineators 56d and 56e as the second feature information of the second light spot. The identification unit 48 then compares the second feature information with the first feature information stored in the storage unit 49 and determines the attribute of the second light spot as a delineator because the second light spot is located within a range of the track L3 as the history information (Yes in S20).

The delineator is not a light emitting object that is a light source itself but is a reflector that reflects the light of a headlamp, etc. Therefore, the light spot of a reflector like a delineator in a distant range R1 (see FIG. 5A) including the vanishing point is darker at a distance than a road light and is difficult to identify because of the small area of the light spot. Therefore, the precision of identification may be lowered if the feature information is calculated by using the light spot in the distant range R1. Accordingly, the precision of identification of the attribute of the first light spot can be improved by using the first feature information calculated by the calculator 44 by excluding the distant range R1. It should be noted that the identification unit 48 may use the second feature information calculated by the calculator 44 by excluding the distant range R1 to identify the attribute of the second light spot.

A description will now be given of a situation where delineators and vehicles in front are located on a straight road at night as seen from the forward monitoring camera. As shown in FIG. 5B, there are cases where a leading vehicle 52 or an oncoming vehicle 54 is located in front of the vehicle other than the delineators 56a-56c. Therefore, when the identification unit 48 identifies that the attribute of the first light spot is not a road related facility by using a publicly known technology (No in S12), or when the identification unit 48 identifies that the attribute of the second light spot is not a road related facility (No in S20), a vehicle identification process (S14) is performed.

In the case the second light spot is positioned within a range of the track L3, which is the history information stored in the storage unit 49, the identification unit 48 identifies in step S18 that the attribute of the second light spot is a delineator. In the case the tail lamp 52a of the leading vehicle 52 is positioned near an extension of the track L3 of the light spots of the delineators 56a-56c as shown in FIG. 5B, the attribute of the light spot corresponding to the tail lamp 52a may be falsely identified as a delineator in S18.

This is addressed by identifying, in S18, whether the attribute of the second light spot is a delineator by also allowing for whether the second light spot is red or not (whether the light spot is a tail lamp or not) or allowing for transition of the brightness or transition of the size of the second light spot. This reduces the likelihood of falsely identifying in S18 the attribute of the light spot corresponding to the vehicle in front as a road related facility.

### (Attribute Identification Process in the Case of a Curved Road)

On the straight road as shown in FIG. 4A and FIG. 5A, the track of light spots of road related facilities defines a straight line. In the case of facilities related to a curved road, however, the track of light spots does not define a straight line. However, the track of light spots is a track along the curved shape of the road so that it is possible to perform an image process as in the case of the straight road if the road shape can be estimated. The road shape is calculated by the calculator 44 based on the information from the GPS navigation ECU 36, the steering sensor 22, or the vehicle speed sensor 24. The identification unit 48 may identify the attribute of the light spot detected by referring to the image information by using the road shape thus calculated and the image information obtained by the image information obtaining unit 46.

(Image Process that Allows for the Attitude of the Vehicle)

The range covered by the image information captured by the forward monitoring camera 16 varies depending on the attitude of the vehicle. For example, the light spot in the image information may waver vertically or horizontally in response to a behavior caused by pitching, rolling, steering correction of the vehicle. Consequently, the range of a track (permitted range for identification of the attribute) may be excessively enlarged, or a curved track of light spots that could not have been foreseen may result. It is therefore necessary to ensure that the behavior of the driver's vehicle does not affect the calculation of feature information used for identification of the attribute as much as possible in order to improve the precision of identification of the attribute of a light spot.

The following methods are conceivable as simple image processes for sensing the movement of the driver's vehicle precisely. These methods make it easy to determine the behavior of the driver's vehicle on a screen and require a small volume of computation (there is no need to use a high-performance IC).
a) The movement common to a plurality of distant light spots is sensed. If any common movement is identified, it is defined as the movement of the driver's vehicle.
b) The movement of a white line is sensed, and the movement of the driver's vehicle is sensed by referring to the way that the white line moves.

FIG. 6A shows a track of light spots that result when the behavior of the vehicle is stable, and FIG. 6B shows the movement of light spots that result when the vehicle pitches.

As shown in FIG. 6A, when the behavior of the vehicle is stable, the movement of light spots often traces a linear track from the vanishing point to a point outside the image. The movement of a distant light spot near the vanishing point (the road light 50a or the leading vehicle 52) per one second is relatively small regardless of whether the light spot represents a vehicle or a road related facility. Meanwhile, the movement of a light spot in a range closer to the driver's vehicle (the road light 50d or the oncoming vehicle 54) is relatively larger if it is within the time frame of one second.

When the vehicle pitches as shown in FIG. 6B, on the other hand, the light spots move in the same direction and in the same amount regardless of whether the light spot is distant or near. Accordingly, the calculator 44 calculates the movement of the driver's vehicle by referring, in particular, to the movement of light spots in a distant range near the vanishing point. The calculator 44 calculates the corrected position of a light spot detected by referring to the image information obtained by the forward monitoring camera 16 while the driver's vehicle pitches, correcting the position in consideration of the movement of the light spot in response to the pitching of the driver's vehicle. The movement of a light spot can equally be corrected when rolling occurs in the driver's vehicle instead of or in addition to pitching. This improves the precision of identification of the attribute of the object by the identification unit 48.

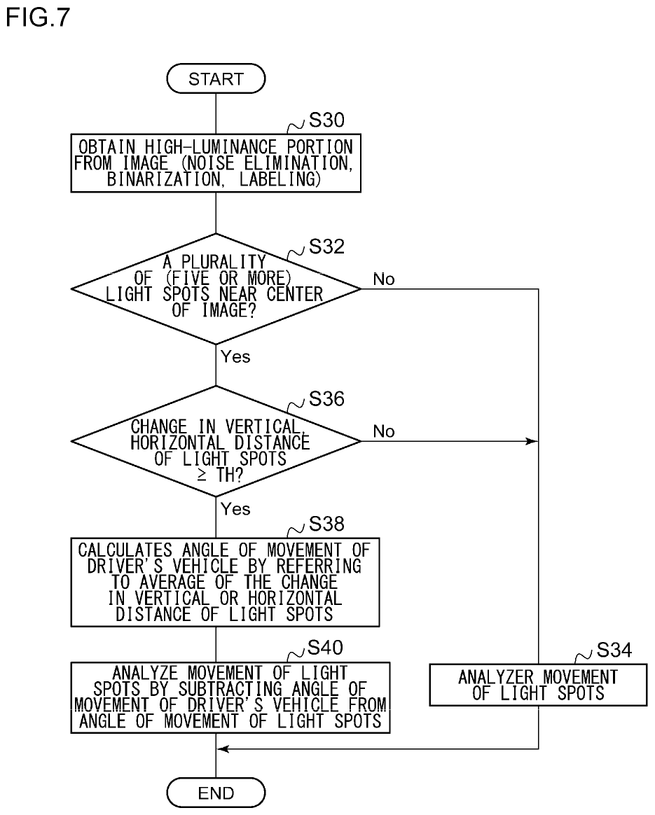

FIG. 7 is a flowchart showing a process for identifying the movement of the driver's vehicle by using a distant light spot. First, the high-brightness portion is calculated by referring to the image information captured (S30). For calculation of a high-luminance portion, noise elimination, binarization, labeling of light spots, or the like is performed. In the absence of a plurality of (e.g., five or more) light spots at the center of the image (near the vanishing point) (No in S32), the image processing ECU 32 analyzes the movement of the light spots as in the process shown in FIG. 3 (S34) and terminates the process of determining the movement of the driver's vehicle.

When there are a plurality of light spots at the center of the image (Yes in S32), the image processing ECU 32 identifies whether the distance of vertical or horizontal movement of the light spots over a predetermined period of time is larger than a threshold value TH (S36). When the distance of vertical or horizontal movement of the light spots is less than the threshold value TH (No in S36), the image processing ECU 32 analyzes the movement of the light spots as in the process shown in FIG. 3 (S34) and terminates the process of determining the movement of the driver's vehicle.

When the distance of vertical or horizontal movement of the light spots is equal to or greater than the threshold value TH (Yes in S36), the image processing ECU 32 calculates the angle of movement (amount of movement) of the driver's vehicle by referring to the average of the change in the vertical or horizontal distance of the light spots (S38). The calculator 44 calculate the angle of movement (amount of movement) of the object itself corresponding to the light spot (S40), by subtracting, for example, the angle of movement (amount of movement) of the driver's vehicle from the angle of movement (amount of movement) of the light spots calculated by referring to the image information. The calculator 44 terminates the process of determining the movement of the driver's vehicle. This reduces the impact of pitching or rolling of the driver's vehicle on the calculation of the movement of the light spot.

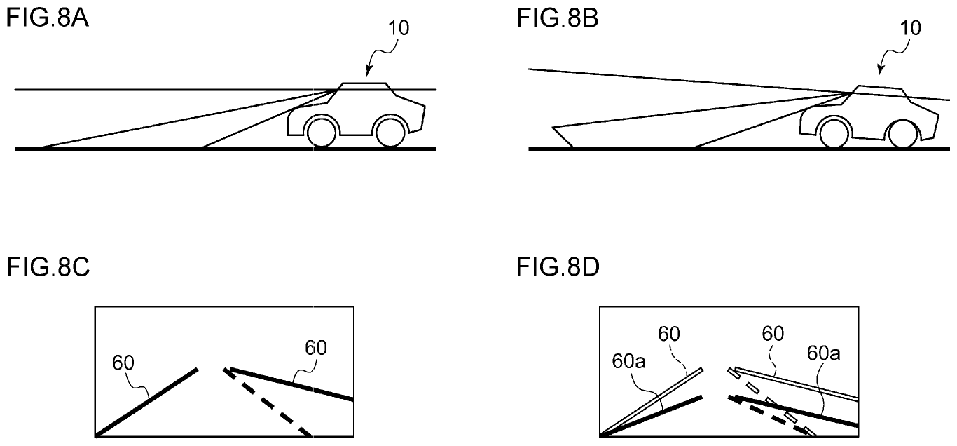

FIG. 8A schematically shows an imaging range of the forward monitoring camera in a state in which the vehicle does not pitch, FIG. 8B shows lanes (white lines) in the imaging range shown in FIG. 8A, FIG. 8C schematically shows an imaging range of the forward monitoring camera in a state in which the vehicle pitches, and FIG. 8D shows lanes (white lines) in the imaging range shown in FIG. 8C.

While the vehicle 10 is traveling parallel to the road as shown in FIG. 8A, white lines 60 are detected in the captured image as shown in FIG. 8B. While the vehicle 10 is traveling non-parallel to the road (such that the front side is lifted, and the rear side dips) as shown in FIG. 8C, white lines 60a are detected in the captured image as shown in FIG. 8D. The angle formed by the two white lines 60s is larger than the angle formed by the two white lines 60.

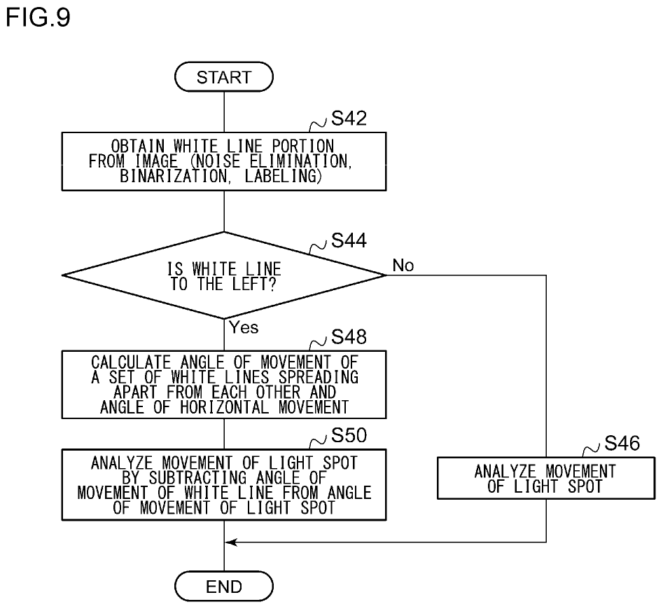

A description will now be given of a method of estimating the movement of the driver's vehicle (attitude) by referring to the change in the gradient of nearby white line. FIG. 9 is a flowchart showing a process of determining the movement of the driver's vehicle by using a nearby white line. First, a white line portion is calculated by referring to the image information captured (S42). For calculation of a white line portion, noise elimination, binarization, labeling of light spots, or the like is performed. The image processing ECU 32 determines whether the calculated white line is located to the left of the driver's vehicle (S44). When it is determined that no white lines are located to the left of the driver's vehicle (No in S44), the image processing ECU 32 analyzes the movement of the light spots as in the process shown in FIG. 3 (S46) and terminates the process of determining the movement of the driver's vehicle.

When it is determined that the white line is located to the left of the driver's vehicle (Yes in S44), the image processing ECU 32 calculates an angle of swaying movement of a set of white lines spreading apart from each other (angle formed by two white lines) or an angle of movement of the white line in the horizontal direction (in the case the vehicle is rolling) (S48). The calculator 44 subtracts the angle of movement (amount of movement) of the white line from the angle of movement (amount of movement) of the light spot calculated by referring to the image information so as to calculate an angle of movement (amount of movement) of the object itself corresponding to the light spot (S50) and terminates the process of determining the movement of the driver's vehicle. This reduces the impact of pitching or rolling of the driver's vehicle on the calculation of the movement of the light spot.

The embodiments of the present invention are not limited to those described above and appropriate combinations or replacements of the features of the embodiments are also encompassed by the present invention. The embodiments may be modified by way of combinations, rearranging of the processing sequence, design changes, etc., based on the knowledge of a skilled person, and such modifications are also within the scope of the present invention.

What is claimed is:

1. An image processing device comprising:
an identification unit that identifies whether an attribute of a first light spot included in image information capturing a scenery in front of a vehicle is a facility related to a road, by referring to first feature information on the first light spot calculated by referring to the image information; and
a storage unit that stores the first feature information when the attribute of the first light spot is identified as a facility related to the road, wherein
the identification unit identifies whether an attribute of a second light spot included in the image information is a facility related to the road, by using the first feature information stored.

2. The image processing device according to claim 1, wherein
the identification unit identifies the attribute of the second light spot by comparing second feature information on the second light spot calculated by referring to the image information with the first feature information stored.

3. The image processing device according to claim 2, wherein
when the second feature information has information in common with the first feature information, the identification unit identifies that the attribute of the second light spot is a facility related to the road.

4. The image processing device according to claim 2, wherein
when the identification unit identifies that the attribute of the second light spot is not a facility related to the road, the identification unit identifies whether the attribute of the second light spot is a vehicle in front traveling in front of the vehicle, based on the second feature information.

5. The image processing device according to claim 1, wherein
the identification unit identifies the attribute of the first light spot by using the first feature information calculated by referring to a nearby range in the image information that excludes a distant range including a vanishing point.

6. A vehicle lamp comprising:
the image processing device according to claim 1;
a headlamp unit that irradiates a space in front of the vehicle; and
a light distribution control unit that controls light distribution of the headlamp unit in accordance with the attribute of the light spot identified by the image processing device.

7. The vehicle lamp according to claim 6, wherein
the light distribution control unit excludes the light spot for which the attribute is not identified by the image processing device as a vehicle in front, which is traveling in front of the vehicle, from targets of light distribution control of the headlamp unit.

8. The image processing device according to claim 1, wherein
the first feature information includes a track of the first light spot.
